(19) United States
(12) Patent Application Publication
(10) Pub. No.: US 2009/0177971 A1
(43) Pub. Date: Jul. 9, 2009

(54) METHOD AND APPARATUS FOR CONTROLLING DLNA DEVICE IN DLNA NETWORK

(76) Inventors: Young-Jae KIM, Seoul (KR); Yun-Je OH, Yongin-si (KR); Joon-Oo KIM, Suwon-si (KR)

Correspondence Address: CHA & REITER, LLC, 210 ROUTE 4 EAST STE 103, PARAMUS, NJ, 07652, US

(21) Appl. No.: 12/348,367

(22) Filed: Jan. 5, 2009

(30) Foreign Application Priority Data
Jan. 4, 2008 (KR) 10-2008-0001228

(51) Int. Cl. G06F 3/01

(52) U.S. Cl. 715/739

(57) ABSTRACT

Disclosed is a method for controlling a Digital Living Network Alliance (DLNA) device in a DLNA network, the method including the steps of: discovering the DLNA device performing communication with a Universal Plug and Play (UPnP) protocol based format in the DLNA network; converting description provided from the discovered DLNA device into a web-message in order to create a DLNA device list within a corresponding network where the discovered DLNA device is positioned as a web-page; creating the DLNA device list as the web-page, based on the converted web-message, and displaying the DLNA device list; selecting a certain DLNA device from the displayed DLNA device list, and executing/controlling content of the selected DLNA device.

### CLAIM OF PRIORITY

This application claims priority to application entitled “Method And Apparatus For Controlling DLNA Device In DLNA Network” filed with the Korean Intellectual Property Office on Jan. 4, 2008 and assigned Serial No. 2008-0001228, the contents of which are incorporated herein by reference in their entirety.

### BACKGROUND OF THE INVENTION

1. Field of the Invention

The present invention relates to a Digital Living Network Alliance (DLNA) network, and more particularly to a method and apparatus for controlling a DLNA device in a DLNA network. This allows a device not provided with a DLNA stack to perform control of DLNA devices within the DLNA network by using internet access.

2. Description of the Related Art

Generally, various electronic devices are used in the home, (for example: information devices (such as, a PC), communication devices (such as a telephone), broadcasting devices (such as a TV), Audio Visual (AV) devices (such as a DVD player and a digital camera), etc.). In order to automatically control such devices, home-automation was proposed and has been commercialized.

At an early stage of the home-automation, each of the above mentioned electronic devices was separately controlled by using a telephone or infrared rays. These methods of home-automation offered no connection or communication between electronic devices.

Further developments in communication technology employ a network built between electronic devices and a controller for controlling the network. Such a system for integrating and/or administering electronic devices through a network built between the electronic devices denotes a ‘home-network system’.

In the home-network system, various kinds of networked devices (for example: a TV, a washing machine, a microwave oven, a gas range, an audio player, an air conditioner, a boiler, a lighting device, a gas valve, a front door sensor, etc.) are connected to a controller, such as a home gateway or a home server, and can be controlled via a terminal (for example, a remote control).

Standardization efforts around home-network systems have developed, including a ‘DLNA (Digital Living Network Alliance)’. DLNA is a standard for controlling home information electronic devices (for example, a TV, a VTR, a digital camera, an audio system, etc.) and has been influential.

The DLNA has focused on the sharing of all content and information provided by electronic devices in the home. In other words, the DLNA allows digital media content stored in a personal area device, such as a mobile device, a PC, etc., to be shared by other home devices, and thus allows a user to conveniently enjoy digital media content no matter where they are positioned at home and no matter on which device they wish to access it.

In the DLNA, emphasis is placed on solving problems related to interoperability of devices. The DLNA, based on UPnP (Universal Plug and Play) technology, includes standardization on physical media network transmission, a media format, a streaming protocol, DRM (Digital Right Management), and other topics related to controlling and moving digital content between devices. More specifically, in the DLNA, network connection is based on an Internet Protocol (IP). The IP is a basic network communication protocol of a device operating on the internet, and makes it possible to exchange information between application programs operating on various media in a transparent way. Accordingly, every DLNA device can communicate with other devices connected to the internet wherever it is positioned throughout the world. For example, a wireless-enabled PC (or a STB) provided with a DLNA middleware may wirelessly transmits media content to a living room TV via an 802.11 AP (Access Point) connected to an Ethernet cable.

Then, as a physical layer of a DLNA, a wired high speed Ethernet (802.11u) and a wireless Ethernet (802.11a/b/g) can be used. The stability of the use of wired Ethernet for this purpose has already been proven. Meanwhile, wireless Ethernet continues to grow in popularity and reliability; Wi-Fi has been adopted with the continued proliferation of wireless home network communication.

DLNA also includes technology for discovering/controlling a device within a DLNA network. This occurs by automatic configuration of a networking setting, such as an IP address, and recognition of another device existing in the network, which is based on a conventional UPnP AV Architecture and a conventional UPnP device architecture. DLNA also uses the same technology for discovering/controlling a service within the DLNA network.

FIG. 1 illustrates a schematic configuration of a conventional DLNA network. Referring to FIG. 1, a DLNA network is based on a UPnP protocol, and performs communication with a device connected to the DLNA network with a format based on a UPnP protocol.

The DLNA network includes a Digital Media Server (DMS) 114, a Digital Media Player (DMP) 112, a Digital Media Renderer (DMR) 110, and a Digital Media Control (DMC) 116.

The DMS 114 includes a broadcast receiver/middleware for receiving digital broadcasting, and can include, for example: a VCR, a CD player, a DVD player, an MP3 player, a set-top box (STB), a TV tuner, a PC, etc. As described above, the DMS 114 searches its own digital media content items so that a DLNA network user can play or distribute the content. The DMR 110 executes selected media content, and the DMP 112 selects and/or controls media content provided from the DMS 114 and executes the selected media content, through the DMC 116.

As described above, devices designed in accordance with a DLNA guideline, including by way of example, the DMS, the DMP, the DMR and the DMC, may freely share media content, such as music, pictures, video, etc. with each other in a DLNA network.

However, in a conventional DLNA network, only a device provided with a software stack in accordance with a DLNA guideline is available for DLNA service. Thus, when a device not supporting a DLNA is positioned in a DLNA supporting network, it is impossible to use a DLNA service, and thus to share content, etc. within the DLNA network.

Therefore, it is urgently required to develop a scheme of controlling devices within a DLNA network, in which a device not supporting a DLNA can share content, etc. with devices within the DLNA network and can receive DLNA services.

### SUMMARY OF THE INVENTION

Accordingly, the present invention solves the above-mentioned problems occurring in the prior art, and the present invention provides a method of performing control of non-DLNA devices within a DLNA network by using a mobile terminal through connection in a similar way to web-surfing, the mobile terminal not supporting a DLNA device due to lack of a DLNA stack, but being capable of accessing the internet.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 illustrates a schematic configuration of a prior art DLNA network;

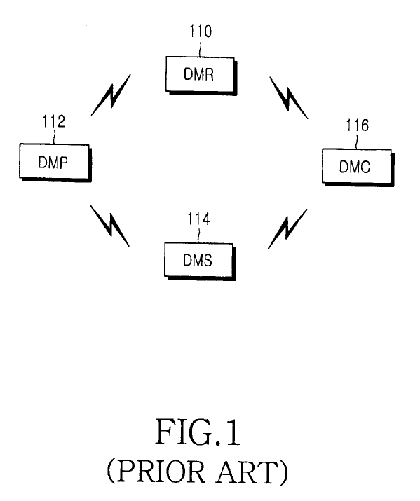

FIG. 2 illustrates a schematic configuration of a system for a DLNA network according to an embodiment of the present invention;

FIG. 3 is a block diagram illustrating a WCP in a DLNA system according to the present invention; and

FIG. 4 is a flow diagram illustrating a method of controlling a DLNA device of a DLNA network according to an embodiment of the present invention.

### DETAILED DESCRIPTION OF THE INVENTION

Hereinafter, exemplary embodiments of the present invention will be described in detail with reference to the accompanying drawings. For the purposes of clarity and simplicity, a detailed description of known functions and configurations incorporated herein is omitted to avoid making the subject matter of the present invention unclear.

First, the present invention is based on the premise that a DLNA network according to the present invention utilizes a UPnP (Universal Plug and Play) protocol and is a wired/wireless network including a communication device with a UPnP-based protocol format. The communication device is connected to the DLNA network.

Also, a DLNA system of the present invention allows various kinds of devices connected to the DLNA network to share digital content between them. For example, it is possible to freely reproduce AV content stored in a digital multimedia server by a digital media player or the digital multimedia server.

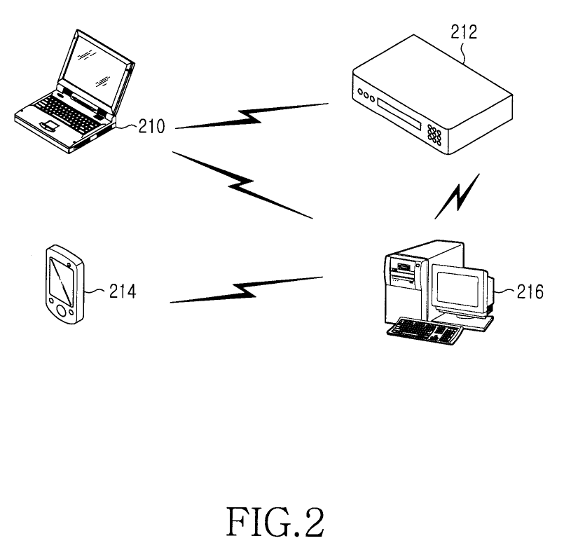

FIG. 2 illustrates a schematic configuration of a system for a DLNA network according to an embodiment of the present invention.

Referring to FIG. 2, the DLNA system includes a Digital Media Server (DMS) 212, a Digital Media Player (DMP) 210, and a Web Control Point (WCP) 216.

The DMS 212 communicates with at least one DMP 210 within the DLNA network, and controls the DMP 210 while providing a multimedia service to the DMP 210. Also, the DMS 212 is provided with a broadcast receiver and/or middleware for receiving broadcasting, and can include a VCR, a CD player, a DVD player, an MP3 player, a set-top box (STB), a digital video recorder (DVR), a TV tuner, a radio tuner, a PC, etc.

The DMP 210 plays digital multimedia content provided via the DMS 212, and performs wired/wireless communication with the DMS 212. DMP 210 includes a Digital Media Renderer (DMR) for executing media content selected by a DLNA network user or the DMS 212, and a Digital Media Control (DMC) for controlling the media content.

The WCP 216 performs communication with a non-DLNA device 214 (not supporting a DLNA network service) via a web browser. The non-DLNA device 214 is not included in the DLNA network. In addition, the WCP 216 includes a DLNA stack of a DLNA communication protocol, and performs communication with DLNA devices (for example, the DMP 210 and the DMS 212) included in the DLNA network through the DLNA stack, thereby allowing the non-DLNA device 214 to control the DLNA devices.

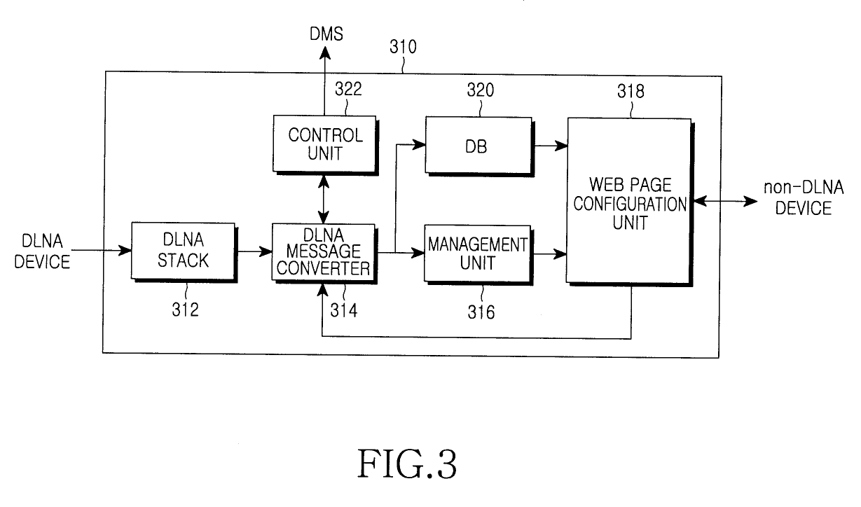

Hereinafter, specific operation of the above described WCP 216 will be described in detail with reference to FIG. 3.

FIG. 3 is a block diagram illustrating WCP in a DLNA system according to the present invention.

Referring to FIG. 3, the WCP 310 includes a DLNA stack 312, a DLNA message converter 314, a management unit 316, a database (DB) 320, a control unit 322, and a web page configuration unit 318.

The DLNA stack 312 performs the following functions based on a UPnP protocol: discovery, description, eventing, a Connection Manager Service, a Rendering Control service, an AV transmission service, and a content directory service. These functions allow the performance of communication with a DMS or a DMP in a DLNA network (in other words, in order to perform communication between various devices in the DLNA network).

The DLNA stack 312 according to the present invention uses communication protocol technology used in a DLNA network that is known to one of ordinary skill in the art, and therefore its specific explanation will be omitted.

The DLNA message converter 314 converts a message input from a DLNA device via the DLNA stack 312, and outputs the converted message to the management unit 316. Also, DLNA message converter 314 converts a message from a non-DLNA device input as a web-browser type message via the web page configuration unit 318 into a DLNA message recognizable by a DLNA device in order to transfer the message to a DLNA device.

After DLNA stack 312 discovers a DLNA device within the DLNA network, DLNA message converter 314 converts and outputs a description of the discovered DLNA device. Then, the management unit 316 registers the DLNA device and manages it.

The web page configuration unit 318 configures a list on the DLNA device registered in the management unit 316 as a web-page. In other words, the web page configuration unit 318 creates the DLNA device list as a web-page capable of being interpretable in a web browser by using an XML (extensible markup language) of HTML for creating an internet web page, thereby allowing a user to access the list. Thus, when a non-DLNA device (not supporting a DLNA service) accesses the web page configuration unit 318 of the WCP 310, the DLNA device list of the DLNA network is displayed as a web-page, thereby allowing a user to select a certain DLNA device from the DLNA device list. Herein, the DLNA device list may be on at least one DMP included in a DMS within the DLNA network, the DMP receiving a service from the DMS, or on whole DMSs positioned within the DLNA network.

When the non-DLNA device selects a certain DLNA device from the DLNA device list of the DLNA network, a web-browser type message on the selection transfers via the DLNA message converter 314 to the selected DLNA device, for example, a DMS. Then, the DMS which receives the message transfers a response message of a browsed result to the WCP 310, and then the DB 320 stores and manages the result. Web page configuration unit 318 creates the browsed result stored in the DB 320 as a web-page which can be displayed upon request by the non-DLNA device through a web-browser of the non-DLNA device.

The control unit 322 controls execution of at least one DMP of a DMS corresponding to a message output from the DLNA message converter 314.

Meanwhile, although not shown in FIG. 3, the WCP 310 may include a receiving unit for receiving a discovery signal transferred from a DLNA device and inputting the signal to the DLNA stack. The discovery and inputting may employ conventionally technology generally known to one of ordinary skill in the art, and thus the specific explanation will be omitted.

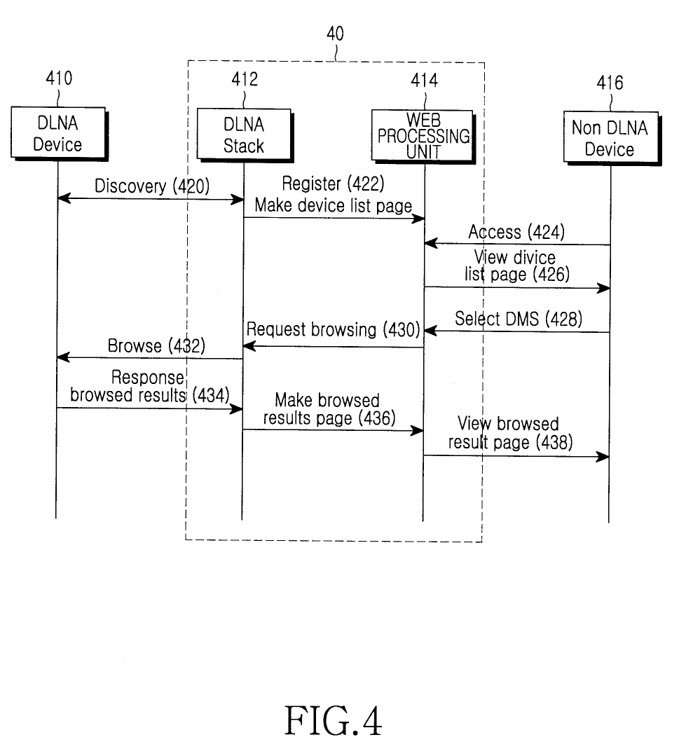

Hereinafter, a method of controlling a DLNA device in a DLNA network according to a preferred embodiment of the present invention will be described with reference to the whole configuration of the present invention and FIG. 4.

FIG. 4 is a flow diagram illustrating a method of controlling a DLNA device of a DLNA network according to an embodiment of the present invention. In explaining the operation of the WCP proposed in the present invention (as shown in FIG. 3), WCP components are classified into a DLNA stack for a DLNA service and a web processing unit for a web browser, as shown in FIG. 4.

Referring to FIG. 4, a DLNA stack 412 of a WCP 40 discovers a DLNA device within a DLNA network in step 420. DLNA stack 412 then creates a DLNA device list of a DLNA network corresponding to the discovered DLNA device as a web-page via a web processing unit 414 of the WCP 40 and registers the list in step 422.

When a non-DLNA device 416 not supporting a DLNA service tries to access a DLNA device within the DLNA network via the web processing unit 414 of the WCP 40 in step 424, the web processing unit 414 of the WCP 40 displays the DLNA device list of the DLNA network as a web-page in step 426.

When a user of the non-DLNA device 416 selects a certain DLNA device from the displayed DLNA device list of the DLNA network in step 428, the web processing unit 414 of the WCP 40 transmits a browsing request of the DLNA device selected in the step 428 to the DLNA stack 412 within the WCP 40 in step 430. Then, the DLNA stack 412 receives the browsing request of the selected DLNA device from the web processing unit 414, and transmits the request to a corresponding DLNA device 410 in step 432.

Meanwhile, the DLNA device 410 which has received the request from the DLNA stack 412 of the WCP 40 transmits a response message of a browsed result to the DLNA stack 412 in step 434, and the DLNA stack 412 creates the browsed result as a web-page and registers/stores the result in step 436. Upon request by a user of the non-DLNA device 416, the result is displayed through a web-browser of the corresponding non-DLNA in step 438.

As described above, a method and apparatus for controlling a DLNA device in a DLNA network according to an embodiment of the present invention may be performed. While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for controlling a Digital Living Network Alliance (DLNA) device in a DLNA network, the method comprising the steps of:
discovering a DLNA device performing communication with a Universal Plug and Play (UPnP) protocol based format in the DLNA network;
converting a description provided by the discovered DLNA device into a web-message;
creating a DLNA device list within a corresponding network where the discovered DLNA device is positioned as a web-page based at least in part on the converted web-message;
displaying the DLNA device list;
selecting a certain DLNA device from the displayed DLNA device list; and
executing/controlling content of the selected DLNA device.

2. The method as claimed in claim 1, further comprising the steps of registering and managing the DLNA device list created as the web-page.

3. The method as claimed in claim 1, wherein the step of executing/controlling the content of the selected DLNA device comprises the steps of:
converting the web-message into a DLNA message capable of communicating with the DLNA device so as to make a browsing/executing request of the content of the selected DLNA device;
transferring the converted DLNA message to a corresponding DLNA device;
storing a result corresponding to the converted DLNA message; and
creating and displaying the stored result as a web page.

4. The method as claimed in claim 1, wherein the DLNA device comprises:
a Digital Media Server (DMS) for communicating with at least one Digital Media Player (DMP) within the DLNA network and controlling the DMP_while providing a multimedia service to the DMP; and wherein the DMP performs wired/wireless communication with the DMS by executing/controlling digital multimedia content provided via the DMS.

5. The method as claimed in claim 1, wherein the DLNA device list comprises the DMP included in the DMS within the DLNA network, the DMP receiving the service from the DMS, or whole DMSs positioned within the DLNA network.

6. An apparatus for controlling a DLNA device in a DLNA network, the apparatus comprising:
a DLNA stack for performing communication between at least two DLNA devices within the DLNA network, based on a UPnP protocol;
a DLNA message converter for converting/outputting a DLNA device list input via the DLNA stack into a web-browser type message, the DLNA device list being accessible on a corresponding network where the DLNA device is positioned, and converting/outputting another web-browser type message input via a web-page configuration unit into a DLNA message recognizable by the DLNA device,
a management unit for registering and managing a corresponding DLNA device of the converted web-browser type message output from the DLNA message converter via the DLNA stack;
a web page configuration unit for creating/displaying the DLNA device list registered in the management unit as a web page in such a manner that the list can be accessible by a web browser; and
a database (DB) for storing and outputting a browsed result on the DLNA device list selected via the web page configuration unit.

7. The apparatus as claimed in claim 6, wherein the web-browser type message is a message which allows for executing, browsing and controlling a DLNA device selected by an external device not supporting a DLNA.

8. The apparatus as claimed in claim 6, further comprising a control unit for controlling execution of at least one device within a network where a corresponding DLNA device of the message output from the DLNA message converter is positioned.

9. The apparatus as claimed in claim 6, wherein the DLNA device comprises:
a DMS for communicating with at least one DMP within the DLNA network, controlling the DMP, and providing a multimedia service to the DMP; and
the DMP for performing wired/wireless communication with the DMS by executing/controlling digital multimedia content provided via the DMS.

10. The apparatus as claimed in claim 6, wherein the DMP comprises:
a Digital Media Renderer (DMR) for executing multimedia content selected by the DMS; and
a Digital Media Control (DMC) for performing control of the multimedia content executed in the DMR.

11. The apparatus of claim 8, wherein the control unit controls execution of at least one DMP of a DMS corresponding to a message output from the DLNA message converter.

12. The method of claim 1, wherein the selecting step further comprises using a non-DLNA device to perform the selecting.

13. The method of claim 4, wherein, the DLNA device list may be on at least one DMP included in a DMS within the DLNA network, the DMP receiving a service from the DMS, or on whole DMSs positioned within the DLNA network.
